(19) United States
(12) Patent Application Publication
(10) Pub. No.: US 2025/0170524 A1
(43) Pub. Date: May 29, 2025

(54) SYSTEM, APPARATUS, AND METHOD FOR ALKALINE EARTH METAL HYDROXIDE LOOPING FOR CARBON DIOXIDE REMOVAL FROM AIR

(71) Applicant: PARALLEL CARBON INC., Jersey City, NJ (US)

(72) Inventors: Ryan Andrey ANDERSON, Princeton Junction, NJ (US); Aranzazu CARMONA ORBEZO, Salford Manchester (GB)

(21) Appl. No.: 18/834,437

(22) PCT Filed: Jan. 31, 2023
(86) PCT No.: PCT/US2023/012004

§ 371 Date: Jul. 30, 2024

Related U.S. Application Data
(60) Provisional application No. 63/305,113, filed on Jan. 31, 2022.

(51) Int. Cl. B01D 53/62; B01D 53/82; B01D 53/96; C01B 32/50; C25B 9/15

(52) U.S. Cl. CPC B01D 53/62; B01D 53/82; B01D 53/965; C01B 32/50; C25B 9/15; B01D 2251/404; B01D 2251/604; B01D 2257/504; B01D 2258/06

(57) ABSTRACT

The present application relates to the field of carbon capture. Embodiments of the present application provide systems, devices, and methods relating to metal hydroxide looping for capturing atmospheric carbon dioxide. Related systems for the electrolytic production of acids and bases for chemical processing and for materials handling are also described.

### INCORPORATION BY REFERENCE OF RELATED PATENT APPLICATIONS

This application is based upon and claims the benefit of priority under 35 U.S.C. § 119(e) to U.S. Provisional Application No. 63/305,113, filed Jan. 31, 2022, the entire contents of all of which are incorporated herein by reference in their entirety.

### FIELD OF THE INVENTION

The present application relates to the field of carbon capture. Embodiments of the present application provide systems, apparatuses, devices, and methods relating to metal hydroxide looping for capturing atmospheric carbon dioxide. Related systems for electrolytic production of acids and bases for chemical processing and materials handling are also described.

### BACKGROUND

Carbon dioxide (CO₂) makes up the vast majority of greenhouse gas emissions globally. Greenhouse gases trap heat and make the planet warmer. The contribution of CO₂ to global warming is well-documented. Carbon dioxide is produced in a variety of sectors, including the transportation, electricity, industry, residential, commercial, and agricultural sectors. As of December 2022, the Mauna Loa observatory (NOAA, Hawaii) measured atmospheric CO₂ to exceed 415 ppm. As CO₂ emission continues, mitigation technologies will not be effective enough to avoid further increases in Earth's temperature, and CO₂ levels may breach 450 ppm by mid-century. Atmospheric carbon dioxide removal and recycling is necessary to prevent catastrophic climate change.

Direct air capture of CO₂ is a promising strategy for addressing concerns relating to greenhouse gases, particularly when the CO₂ is permanently or semi-permanently prevented from re-entering the atmosphere. Another application of direct air capture is to supply recycled CO₂ as a feedstock (alongside a source of hydrogen, H₂) to synthesize low-carbon fuels or chemicals that displace demand for fossil fuels (e.g., methane, methanol, ethanol, plastics).

Direct air capture processes produce CO₂ from air by cyclically absorbing CO₂ with sorbents, then liberating (i.e., releasing) the sorbent's CO₂ to regenerate the sorbent's CO₂ uptake capacity. During direct air capture, sorbents in contact with air absorb CO₂ with a certain CO₂ uptake rate and approach a maximum CO₂ uptake extent. Liberation and regeneration require a change in thermodynamic environment generated by changing temperature (i.e., heating), pressure (i.e., vacuum), moisture (i.e., humidity), electric charge (i.e., voltage or current), or some combination thereof. This step in a direct air capture process is usually the most energy intensive.

One direct air capture strategy is to use a sorbent comprised of alkali metal hydroxides or alkaline earth metal hydroxides that react with CO₂ to obtain alkali metal carbonates or alkaline earth metal carbonates via a “carbonation” reaction. Some metal oxide direct air capture sorbents react with water to become metal hydroxides before reacting with CO₂ at ambient air conditions (for example calcium oxide reacts with water to transform into calcium hydroxide before the carbonation reaction. A generalized reaction for metal (Me) hydroxides with monovalent or divalent cations is shown below:

aMeₓ(OH)_{y}+bCO₂→xMeₐ(CO₃)_{b}+(ay/2)H₂O

Commercialization is ongoing for direct air capture technologies using metal hydroxides including sodium hydroxide (NaOH), potassium hydroxide (KOH), calcium hydroxide (Ca(OH)₂), magnesium hydroxide (Mg(OH)₂), among others.

One instantiation of direct air capture technology actively forces air through an air-liquid contactor to absorb CO₂. The NaOH and/or KOH sorbent is dissolved in water, forms sodium or potassium carbonate upon CO₂ uptake, and is subsequently reacted with Ca(OH)₂ to produce CaCO₃. This carbonate ion transfer regenerates the NaOH and/or KOH, but does not liberate CO₂. Further treatment of CaCO₃, for example in an oxygen-fired calciner at temperatures exceeding 900° C., is needed to release CO₂ and regenerate the calcium source.

Another direct air capture process design passively contacts Ca(OH)₂ with air moving with natural convection and diffusion. Similar high-temperature processing, including with electric calciners or steam calciners, is used to release CO₂ and regenerate the sorbent due to the formation of CaCO₃ upon CO₂ uptake. However, the high-temperature processing forms calcium oxide which must be hydrated, or ‘slaked’, to reform the Ca(OH)₂ sorbent.

This cyclical use of calcium for carbon capture is commonly referred to as “looping” or “calcium looping”. However, calcium looping has well-documented challenges with cyclic degradation of sorbent. The high temperatures used to liberate CO₂ can sinter particles, reduce reactive surface area, and reduce CO₂ uptake capacity. This degradation effect can limit the useful life of a sorbent, adding sorbent replacement, transport, and disposal costs. Furthermore, moisture improves carbonation reaction rates for low temperature calcium looping, but excess water reduces calcination efficiency, complicating operations.

Academic studies generally indicate that carbon capture processes designed to use metal hydroxides offer lower-than-average capital costs while claiming better-than-average supply chain infrastructure. Nevertheless, challenges remain. Current technologies for atmospheric carbon capture remain expensive and may be difficult to implement and scale. Calcium looping is an energy intensive process, and the high temperatures need consistent power for thermal efficiency and quality control. Supplying high temperatures with inexpensive, 24/7 carbon-free energy is not yet a reality. The most affordable carbon-free electricity options today are wind and solar photovoltaic power, but these sources are intermittent so are poorly suited to maintaining calcination temperatures. Therefore, there remains a need for more carbon capture technologies that are more compatible and cost-efficient with intermittent power.

### SUMMARY

Recognizing the need for better carbon capture technologies, the inventors of the present application have invented new systems, devices, and methods relating to metal hydroxide looping for capturing carbon dioxide.

In particular, certain embodiments of the present application provide aqueous processing for CO₂ liberation from carbonates, as opposed to thermal processing, which is typically incompatible with many salts, including alkali salts, chloride salts, nitrate salts, fluoride salts, alkali hydroxides, etc. In a preferred embodiment, the system includes the use of a saturated salt or mixture of salts that mediate humidity during metal hydroxide carbonation, thereby enhancing metal hydroxide carbonation extent and carbonation rate. In a preferred embodiment, the system uses the same salt or mixture of salts as an electrolyte in a water electrolyzer used to produce acids and bases for aqueous processing.

Embodiments of the present application offer advantages over the state of the art leading to more cost-effective carbon capture. For example, embodiments of the present application provide for aqueous precipitation of highly reactive metal hydroxides with a mean particle size less than 1 micron and specific surface area-to-volume ratios superior to metal hydroxides produced by slaking subsequent to high-temperature metal carbonate processing. Furthermore, in certain embodiments metal hydroxides convert directly to metal carbonates in ambient air conditions, eliminating the intermediate metal oxide-to-hydroxide hydration step on the path to metal hydroxide carbonation. Additionally, aqueous precipitation avoids particle reactivity degradation due to sintering from prolonged or repeated thermal processing, extending the useful lifetime of sorbent feedstock. Aqueous processing is preferred to thermal processing for metal hydroxide carbon capture (also called “mineral looping” or, more specific to calcium-based sorbents, “calcium looping”), as thermal processing could require any number of additional processing steps that increase energy demand. These steps include drying, washing and/or rinsing solid carbonate of any water soluble salt or electrolyte, dewatering (or otherwise drying) and evaporating excess water from the solids produced or retained during ambient carbonation. Yet another advantage of aqueous processing is derived from lower operating temperatures as compared to thermal processing, as the high temperatures (900° C.) used in a thermal processing system are usually derived from combustion of fossil fuels. In comparison, aqueous processes are highly compatible with intermittently available renewable energy sources. Further advantages of embodiments of the present application will become apparent from the description below and from review of the figures of drawing.

In some embodiments, the application provides a system for capturing carbon dioxide from a gas (e.g., atmosphere or an air stream). In one embodiment, the system includes a metal hydroxide carbonation rack, for example racked trays of metal hydroxide undergoing carbonation in ambient air conditions (also called “mineral carbonation” or “weathering”), a liberation vessel, a regeneration vessel, a solid-liquid separation method, and a water electrolyzer operated in a manner consistent with chemical (acid and base) production and water splitting (hydrogen and oxygen production) required by the direct air capture system. The system optionally includes an energy recovery system, such as a fuel cell. In a preferred embodiment, the system includes the use of metal hydroxide particles with a saturated salt solution that mediates humidity to 25%-99%, or most preferably 50%-95%, and is distributed within and among the metal hydroxide particles which may enhance metal hydroxide carbonation extent and carbonation rate. In a preferred embodiment, the metal hydroxide looping system uses the same salt or mixture of salts as an electrolyte in the water electrolyzer referred to above.

In other embodiments, the application provides a method for capturing carbon dioxide from a gas (e.g., atmosphere or an air stream). In some embodiments, the method includes providing a metal hydroxide carbonation rack and converting a metal hydroxide to a metal carbonate, as discussed in the embodiments below. In some embodiments, the method includes providing liberation and regeneration vessels to liberate carbon dioxide from carbonate and regenerate a metal hydroxide, as discussed in the embodiments below. In some embodiments, the method includes providing a water electrolyzer for producing acidic and basic solutions, as discussed in the embodiments below. In some embodiments, the method includes providing an energy recovery system for recovering energy consumed by the system, e.g., by the water electrolyzer, by combining hydrogen and oxygen to form water, e.g., in a fuel cell or by combustion.

In other embodiments, the application provides a novel water electrolyzer for producing a continuous stream of acids, bases, hydrogen and oxygen. It should be understood that certain parts of each system or method may be combined for direct air capture, or may be used independently.

It should be understood the present application also encompasses the subprocesses and subcombinations of the embodiments discussed herein. Such subprocesses and subcombinations may be used independently or may be incorporated into larger systems or methods. It is the intent of the inventors that the present application shall encompass subprocesses and subcombinations as well as the larger systems and methods.

Further objects, features, and advantages of the present application will become apparent from the detailed description of preferred embodiments which is set forth below when considered together with the figures and drawings.

### BRIEF DESCRIPTION OF THE FIGURES OF DRAWING

FIG. 1 depicts an embodiment of the process flow diagram of a system and method of the present application.

FIG. 2 depicts an embodiment of a process flow diagram of a system and method of the present application.

FIG. 3 depicts an embodiment of a process flow diagram of a system and method of the present application.

FIG. 4 depicts an embodiment of the process flow diagram of a system and method of the present application.

FIG. 5 depicts an embodiment of a process flow diagram of a system and method of the present application.

FIG. 6 depicts embodiments of several electrode architectures and electrode materials.

FIG. 7 depicts an embodiment of the process flow diagram of a system and method of the present application.

### DETAILED DESCRIPTION OF PREFERRED EMBODIMENTS

### Definitions

In the context of the present application, the terms “about” and “approximately” mean any value that is within ±10% of the value referred to.

The terms “mineral” and “metal hydroxide” and the terms containing these as sub parts are used interchangeably. For example, the terms “mineral carbonation rack” and “metal hydroxide carbonation rack” should be considered interchangeable.

The terms “liberation vessel” and “liberation tank” are used interchangeably and refer to the carbon dioxide liberation vessel discussed herein. The terms “regeneration vessel” and “regeneration tank” are used interchangeably and refer to the regeneration vessel discussed herein. The terms “settling vessel”, “settling tank”, “clarification vessel”, and “clarification tank” are used interchangeably and refer to the settling tank discussed herein. One of ordinary skill in the art would understand the term “vessel” to include any process container/reactor appropriate for the step discussed, including a fluidized reactor, pellet reactor, continuously stirred reactor, plug flow reactor, etc. It should be understood embodiments in the present application providing or discussing a settling tank may alternatively be provided using or embodied by any clarification equipment, including any hopper, basin, tank, baffled basin, baffled tank, hopper bottom tank, sedimentation tank, radial flow sedimentation tank, rectangular sedimentation tank, spiral flow sedimentation tank, etc.

The terms “electrolyzer” and “electrolyzer stack” are generally used interchangeably unless otherwise specified or unless referring to the construction, architecture, or components of an individual electrolyzer cell. Embodiments that include an “electrolyzer” or “electrolyzer stack” should be understood to relate to single and multiple-cell constructions.

The term “pellet” is used to refer to body of material and unless otherwise specified includes granules, granulates, spheronized granules, powders, extruded forms (such as strings, hollow tubes, and helicoids), as well as other geometries.

### Systems and Methods

In some embodiments, the application provides a system for capturing carbon dioxide from a gas (e.g., atmosphere or an air stream). In one embodiment, the system includes a metal hydroxide carbonation rack, for example racked trays of metal hydroxide undergoing carbonation in ambient air conditions (also called “mineral carbonation” or “weathering”), a liberation vessel, a regeneration vessel, a solid-liquid separation method, and a water electrolyzer operated in a manner consistent with chemical (acid and base) production and water splitting (hydrogen and oxygen production) required by the direct air capture system. The system optionally includes an energy recovery system, such as a fuel cell. In a preferred embodiment, the system includes the use of metal hydroxide particles with a saturated salt solution that mediates humidity to roughly 50%-95% and is distributed within and among the metal hydroxide particles which may enhance metal hydroxide carbonation extent and carbonation rate. In a preferred embodiment, the metal hydroxide looping system uses the same salt or mixture of salts as an electrolyte in the water electrolyzer referred to above.

In other embodiments, the application provides a method for capturing carbon dioxide from a gas (e.g., atmosphere or an air stream). In some embodiments, the method includes providing a mineral carbonation rack and converting a metal hydroxide to a metal carbonate, as discussed in the embodiments below. In some embodiments, the method includes providing liberation and regeneration vessels to liberate carbon dioxide from carbonate and regenerate a metal hydroxide, as discussed in the embodiments below. In some embodiments, the method includes providing a water electrolyzer for producing acidic and basic solutions, as discussed in the embodiments below. In some embodiments, the method includes providing an energy recovery system for recovering energy consumed by the system, e.g., by the water electrolyzer, by combining hydrogen and oxygen to form water, e.g., in a fuel cell or by combustion.

In other embodiments, the application provides subprocesses and devices for accomplishing a portion of the systems and methods discussed herein. For example, it should be understood that certain parts of the entire system or entire method may be used independently of the entire system or method.

### Mineral Carbonation

Certain embodiments of the present application include a mineral carbonation rack, for example racked trays of metal hydroxide undergoing mineral carbonation in ambient air conditions and related methods for capturing CO₂ from a gas mixture, for example the atmosphere or an exhaust gas flow. The mineral carbonation rack may contain a plurality of racks and may be open to the atmosphere, partially enclosed (e.g., by a roof, which may protect from rain, gather rainwater, and/or support photovoltaic cells), or essentially fully enclosed. The mineral carbonation rack in some embodiments is configured to support photovoltaic cells. The mineral carbonation rack's trays may be spaced to minimize the pressure drop to allow wind and natural convection to circulate air or another gas containing CO₂ through and over the metal hydroxide. The mineral carbonation rack may utilize fans or other air moving equipment or natural phenomena (e.g., atmospheric wind) to force, blow, or circulate air or another gas containing CO₂ through and over the metal hydroxide. Some embodiments include racked trays of metal hydroxide undergoing mineral carbonation in ambient air conditions and related methods for capturing CO₂ from a gas mixture (e.g., untreated exhaust gas from an upstream process, or exhaust gas from an incomplete upstream carbon capture process). In other embodiments, the mineral carbonation rack may provide other mechanical types of support for the metal hydroxides for permitting or preventing ambient air to flow over and/or around a pellets, granulates, extruded forms, or powder of metal hydroxide, for example rigid, semirigid, or flexible meshes or screens having various geometries. Mechanical structures may be added in some embodiments to block air flow, for example in circumstances where strong winds may be experienced. Some embodiments include an automated system for adjusting the spacing between racked trays in the mineral carbonation rack. Automated adjustment may be undertaken to increase air flow resistance, e.g. to protect against high wind conditions. It should be understood that routine adaptations of the mechanical support of the metal hydroxide are within the scope of the present disclosure.

In one embodiment, the mineral carbonation rack contains a metal hydroxide for capturing CO₂ by producing a metal carbonate. In a preferred embodiment, the metal hydroxide is calcium hydroxide (Ca(OH)₂), which produces calcium carbonate as shown in the reaction below. In other embodiments, the metal hydroxide is selected from the group consisting of (i) alkaline earth metal hydroxides, preferably calcium hydroxide, calcium magnesium hydroxide, magnesium hydroxide, and (ii) calcium silicate hydroxides/hydrates, including tobermorite, afwillite, jennite, and xonotlite, and (iii) magnesium carbonate hydroxides/hydrates, including magnesium carbonate hydroxide, dypingite, artinite, lansfordite, hydromagnesite, nesquehonite, barringtonite, and (iv) magnesium silicate hydroxides/hydrates, including lizardite, serpentine, talc, antigorite, and (v) mixtures thereof, including crystalline, non-crystalline or amorphous forms of the foregoing. Thus, in a particularly preferred embodiment, carbon dioxide is captured in the mineral carbonation racks according to the following carbonation reaction (1):

Ca(OH)₂+CO₂→CaCO₃+H₂O (1)

In some embodiments, the metal hydroxide is provided in the mineral carbonation racks or vessel in pellet form. In some embodiments, the pellets may be physically embodied as granules, spheronized granules, and/or extruded forms such as strings, hollow tubes, helicoids, etc. In some embodiments, the pellets have a mean radius preferably between 0.5 mm to 1 mm, or optionally between 100 nanometers and 1 micron, 1 micron and 10 microns, 10 microns to 0.1 mm, 0.1 mm to 0.5 mm, or 1 mm to 10 mm. When the mean pellet radius is less than 100 microns, it may be considered a powder or powderized. Without being bound by theory, embodiments of the present application include pellets designed to minimize CO₂ diffusion distance and maximize surface area per unit of volume. In some embodiments, the mean diffusion distance is less than 10 mm. In some embodiments, the mean diffusion distance is less than 5 mm. In some embodiments, the mean diffusion distance is between 1-10 mm. In some embodiments, the mean diffusion distance is less than 1 mm. Thus, high surface area shapes with thin sub structures such as helicoids (fusilli/rotini pasta-shaped pellets) are preferred. In some embodiments, the pellets are arranged on trays inside the mineral carbonation racks and a CO₂-containing gas is passed (e.g., passively by convection) between the pellets and/or flowed (e.g., actively with fans, pumps, etc.) over the pellets. In some embodiments, a plurality of trays is arranged inside the mineral carbonation racks. In some embodiments, the trays, or pallets of trays, may be rearranged inside the mineral carbonation racks manually or automatically to optimize carbon capture. In some embodiments, the trays may be manually or automatically removed and/or replaced to optimize carbon capture. In some embodiments, the pellets on the trays may be manually or automatically removed and/or replaced to optimize carbon capture. In some embodiments, the pellets on the trays may be automatically or manually rearranged, e.g., stirred, jostled, vibrated, blown, or otherwise moved mechanically, to optimize carbon capture. In some embodiments, the mineral carbonation racks or vessel contains a sensor for measuring a concentration of CO₂ present in a region proximate to the metal hydroxide or in a stream exiting the mineral carbonation racks or vessel, wherein the sensor is optionally capable of activating a system for removing or rearranging the racks or pellets or providing a notification to an operator. In some embodiments, the mineral carbonation racks or vessel contains a sensor for determining an amount of metal carbonate produced, wherein the sensor is optionally capable of activating a system for removing or rearranging the racks or pellets or providing a notification to an operator.

In some embodiments, the carbonation reaction occurs in the presence of a salt. In some embodiments, the salt enhances and/or mediates the humidity in and around the carbonating metal hydroxides. In some embodiments, the salt may mediate humidity by reducing the evaporation rate or by absorbing moisture. In some embodiments, the salt is a hygroscopic salt (absorbing moisture, e.g., from the CO₂ containing gas). In some embodiments, the salt is slightly hygroscopic or may exhibit deliquescence. In some embodiments, salts may reduce the freezing temperature of water and allow carbonation to continue below 0° C. In the preferred embodiment, the salt is sodium nitrate. In other embodiments, the salt is selected from the group consisting of potassium nitrate, sodium chloride, potassium chloride, sodium carbonate, potassium carbonate, sodium iodide, potassium iodide, magnesium chloride, calcium chloride, magnesium nitrate, calcium nitrate, and combinations or mixtures thereof. In some embodiments, the salt, e.g., potassium nitrate, is provided with a minimum concentration of 0.01M and a maximum concentration equivalent to a fully saturated solution. In other embodiments, the salt includes a fraction of alkali metal hydroxide selected from the group consisting of sodium hydroxide, potassium hydroxide, and combinations of mixtures thereof. In some embodiments, the ratio of salt to alkali metal hydroxide by weight is about 10:1, about 100:1, or between 10:1 and 100:1. In some embodiments, the ratio of salt to metal hydroxide potentially exceeds 1,000,000:1. In some embodiments, the ratio of salt to hydroxide by weight is about 3:1, 4:1, 5:1, 6:1, 7:1, 8:1, 9:1, 10:1, 15:1, 20:1, 25:1, 50:1, or 100:1. Without being bound by theory, it is believed the combined salt and alkali metal hydroxides enhance alkaline earth metal hydroxide carbonation by affecting the chemical and physical carbonation environment, improving CO₂ uptake rate.

In some embodiments, water is intermittently added either directly, via spraying, misting, or soaking the trays or metal hydroxide pellets, or indirectly by controlling external humidity. In some embodiments, evaporated water is condensed and recovered while carbonation is occurring. In some embodiments, humid air condenses in the presence of the humidity mediating salts and water is collected instead of evaporated.

In some embodiments, a purified air stream passes out of the mineral carbonation racks. In some embodiments, the purified air stream contains essentially no CO₂. In some embodiments, the purified air stream contains 1%, 2%, 3%, 4%, 5%, 6%, 7%, 8%, 9%, 10%, 20%, 30%, 40%, 50%, 60%, 70%, 80%, 90%, or 100% of the CO₂ contained in the CO₂-containing gas.

### Carbon Dioxide Liberation and Mineral Regeneration

Some embodiments of the present application include a carbon dioxide liberation vessel and a metal hydroxide regeneration vessel. In some embodiments, these liberation and regeneration vessels are separate vessels. In some embodiments, these liberation and regeneration vessels are a single vessel. In the embodiments of the present application, the metal carbonate produced in the mineral carbonation rack is introduced into the liberation vessel, where carbon dioxide is liberated, and metal ions are produced in solution. In embodiments of the present application, the metal ions are fed to the regeneration vessel, where metal hydroxide is precipitated. In some embodiments, the metal carbonate is automatically introduced into the liberation vessel. In some embodiments, the metal carbonate is manually introduced into the liberation vessel. In some embodiments, the metal ions are automatically introduced into the regeneration vessel. In some embodiments, the metal ions are manually introduced into the regeneration vessel.

In some embodiments, a metal carbonate, optionally still partially wet, is fed to a liberation vessel. In some embodiments, the liberation vessel is operated at a temperature of 20-90° C., or preferably 30-80° C., or more preferably 40-70° C. In a preferred embodiment, an acidic solution is introduced to the liberation vessel. In some embodiments, the liberation vessel is a continuously stirred tank reactor (CSTR). In some embodiments, the solids from the racks are added to an acid in the liberation vessel, optionally produced in a water electrolyzer, to release CO₂ gas, which is removed from the liberation vessel. A metal ion (e.g., Ca²⁺) rich solution is extracted—and in some embodiments, passed through metal carbonate to ensure full acid neutralization of the stream—before being introduced to a regeneration vessel. In some embodiments, a portion of the metal ion rich solution (e.g., Ca²⁺) can be mixed with the metal carbonate prior to introduction into the liberation vessel to suspend the metal carbonate solids (pellets, particles, etc.). In some embodiments, a portion of the metal ion solution may be passed through a vacuum degasser (e.g., with pressure below 1 atm) to liberate dissolved CO₂. In some embodiments, the metal ion solution may be heated to liberate dissolved CO₂. In some embodiments, the metal ion solution may be heated and passed through a vacuum degasser.

In some embodiments, the regeneration vessel is a continuously stirred tank reactor (CSTR). In the regeneration vessel, a basic solution, optionally produced in a water electrolyzer, is added and a metal hydroxide is precipitated. In some embodiments, the regeneration vessel is operated at a temperature of 20-90° C., or preferably 30-80° C., or more preferably 40-70° C. In some embodiments, the metal hydroxide is precipitated in an elevated ionic strength solution. In some embodiments, the elevated ionic strength solution contains salt concentrations between 1-3M. In a preferred embodiment, the ionic strength is elevated with a salt. In a preferred embodiment, the salt is sodium nitrate (NaNO₃).

In some embodiments, after precipitation the metal hydroxide (which may be in the form of a particle suspension (“slurry”)) enters a solid-liquid separation process, which increases the weight % of solids. In some embodiments, the solid-liquid separation process is performed in a tank. In some embodiments, the solid-liquid separation process utilizes a settling tank to agglomerate the particles, sediment, and clarify the slurry. In some embodiments, the separation process utilizes a centrifuge, sedimentation, flotation, flocculation, spray drying, pellet reactor, sieving, filtration, or another similar method of solids liquid separation. In some embodiments, multiple techniques are used concurrently and/or sequentially. In some embodiments, the solid-liquid separation process may be open to a CO₂ containing air stream and partial carbonation of metal hydroxide may occur before or during material handling or before pellets (or other solid metal hydroxide forms) enter the mineral carbonation rack. In some embodiments, the solid-liquid separation process may be repeated to incrementally remove liquid or increase wt. % of solids. In some embodiments, the solid-liquid separation process increases the wt. % of solids to at least 5 wt. %, 10 wt. %, 20 wt. %, or 55 wt. %.

In some embodiments, a thickened suspension (weight % of solids to at least 5 wt. %, 10 wt. %, 20 wt. %, or 55 wt. %) is pumped from the bottom of the settling tank and extruded or granulated to form pellets from the metal hydroxide suspension. In some embodiments, the still-warm pellets are contacted with flowing air to allow partial evaporation and drying of the pellets. In some embodiments, some shrinkage may occur upon drying, which may consolidate the metal hydroxide pellets to prevent substantial geometrical change to the pellets during transport to trays and on pallets to and from racks. In some embodiments, inert solids are added to the particle suspension as a thickening agent to enable extrusion or granulation or other pelletization. In some embodiments, pellets may be formed by coating inert particles. In some embodiments, the inert solids have negligible reactivity with respect to CO₂. In some embodiments, the inert solids may include polymer beads, quartz, silica, sand, clays. In some embodiments, the inert solids may have particle sizes sufficiently large to simplify dewetting. In some embodiments, the inert solids may be graded to enhance material forming and water retention properties of the metal hydroxide pellets. In some embodiments, the inert solids have a density permitting density separation for reclaiming inert solids during processing (low density polymers floating in water or higher density quartz particles sinking/sedimenting).

In some embodiments, the liberation vessel is fed with an acidic solution and a metal carbonate discussed herein, preferably CaCO₃. The liberation vessel may also be optionally fed with an acidic solution, a metal carbonate, and a salt discussed herein, preferably NaNO₃, to reduce CO₂ solubility. In a preferred embodiment, the acidic solution fed to the liberation is produced in a water electrolyzer, preferably a water electrolyzer according to the present application. In some embodiments, the acidic solution produced by the water electrolyzer contains the salt. In some embodiments, the concentration of the salt in the acid solution is between 0.01M and fully saturated, 0.5M-1.5M, 0.8-1.2M, or about 1M. In a preferred embodiment, the salt is present in a concentration preferably greater than 1 M (mol/L), but no less than 0.01 M.

In some embodiments, the acidic solution has a pH value of less than 4, and preferably less than 0. The acidic solution dissolves the metal carbonate and liberates CO₂. In some embodiments, the liberated CO₂ is produced as a high concentration CO₂ gas stream. In a preferred embodiment, the liberation vessel is operated at elevated temperature, 20-90° C., preferably 30-80° C., or more preferably 40-70° C. In some embodiments, the liberation vessel is gas-tight to prevent undesired intrusion of air or loss of CO₂ or liquids while also able to accept intentional solid and liquid inputs. In some embodiments, the liberation vessel is stirred. In some embodiments, the liberation vessel produces a high alkalinity solution containing metal ions, preferably Ca²⁺. The CO₂ produced may optionally be processed with or without compression into products, such as carbonates, aggregates, supplementary cementitious materials (SCM), concrete, plastics, chemicals, fuels, building materials, etc. The CO₂ produced may optionally be processed into storage mediums, including mine tailings, mining products, or injected into geologic storage, including basalt formations, saline aquifers, etc.

In some embodiments, the high alkalinity solution from the liberation vessel is fed to the regeneration vessel. The high alkalinity solution contains metal ions, preferably Ca²⁺ ions. The solution may also optionally contain a salt discussed herein, preferably NaNO₃. In a preferred embodiment, the NaNO₃ is present in high concentration, preferably greater than 1 M (mol/L), but no less than 0.01.M. In some embodiments, the concentration is between 1-3M. In a preferred embodiment, a basic solution is introduced into the regeneration vessel to cause oversaturated metal ions to precipitate metal hydroxide, preferably Ca(OH)₂. In some embodiments, the pH of the basic solution is greater than 13, and more preferably greater than 14. In a preferred embodiment, the regeneration vessel is operated at elevated temperature, 20-90° C., preferably 30-80° C., or more preferably 40-70° C. In some embodiments, the regeneration vessel produces a metal hydroxide particle suspension of sub-micron metal hydroxide particles. Without being bound by theory, it is believed elevated temperatures and high ionic strength created from the sodium nitrate and alkali hydroxide contribute to such particle formation. The metal hydroxide produced may be used for CO₂ capture in the mineral carbonation racks. The metal hydroxide and salt mixture may optionally be partially or fully de-watered/dried prior to being used for CO₂ capture. As discussed above, inert solids may be added to the pellets and, in some embodiments, the inert solids may have particle sizes 10 to 100 microns, 100 microns to 1 mm, or a graded mixture to optimize pellet forming, simplify dewatering, and simplify reuse.

In some embodiments, inert solids are separated from the solution in the liberation vessel, prior to the solution being introduced into the liberation vessel, or downstream of the liberation vessel. In some embodiments, the inert solids are separated using density separation (e.g., low density polymers floating in water or higher density quartz particles sinking/sedimenting), or by using a flotation process in the acid environment of the liberation vessel. Thus, in some embodiments, particle reclamation is performed on the inert solids (e.g., removing particles from the top (skimming) or bottom of the tanks (pumping, raking, etc.). In some embodiments, the inert materials are of sufficiently large particle size to simplify a dewetting processes, for instance with a belt filter press. In some embodiments, density separation is performed using an additional sedimentation tank for inert particle separation after the liberation vessel and before the regeneration vessel. In some embodiments, inert particles may be physically separated from metal carbonates and salty acid with a separation process (e.g., sedimentation or flotation), then de-watered by filtering. Optionally, inert particles may be partially or fully dried (optionally with waste heat).

In some embodiments, the systems and methods of the present application include reservoirs for storing acids and/or bases. In some embodiments, this permits operational continuity in the event of a reduction or loss in electrical power (e.g., based on the use of intermittent renewable energy) or other input required to generate acids and bases. In some embodiments, the reservoirs are embodied as insulated containers or containers stored in an insulated environment, to maintain temperature and reduce energy loss.

### Water Electrolyzer

In another aspect, the present application provides a novel water electrolyzer for producing a continuous stream of acids, bases, hydrogen and oxygen. The water electrolyzer may be used independently of the direct air capture equipment and methods discussed herein, or may be used together with such equipment and methods. For example, when used with direct air capture equipment and methods, the acidic and basic solutions used in the liberation and regeneration vessels may be produced using a water electrolyzer or an electrolyzer stack according to the present application. The H₂ product from the electrolyzer may be provided for commercial or industrial applications including ammonia production, methanol production, direct reduction of iron for steel, other chemical processing operations, etc. The O₂ product from the electrolyzer may be provided for commercial and industrial applications including for oxygen-fired combustion of hydrogen or hydrocarbons, medical applications, or other industrial uses.

In some embodiments, the water electrolyzer of the present application is a membrane-less water electrolyzer. In preferred embodiments, the water electrolyzer is operated with an electrolyte, preferably NaNO₃. In some embodiments, the electrolyte is selected from the group consisting of sodium nitrate, potassium nitrate, sodium chloride, potassium chloride, sodium carbonate, potassium carbonate, sodium iodide, potassium iodide, magnesium chloride, calcium chloride, magnesium nitrate, calcium nitrate, and combinations or mixtures thereof. In other embodiments, the salt includes a fraction of alkali hydroxide selected from the group consisting of sodium hydroxide, potassium hydroxide, and combinations of mixtures thereof. In some embodiments, the salt has a minimum concentration of 0.01M and a maximum concentration equal to a fully saturated solution. In a preferred embodiment, the salt is NaNO₃ and the concentration (entering electrolyzer or leaving regeneration vessel or settling tank) is 1-3M. In some embodiments, an acid and/or base produced by the electrolyzer has a lower salt concentration because a fraction of the salt entering the electrolyzer has been split to create the acid and base. In some embodiments, the alkali hydroxide is at a concentration of 0.01-0.1M or 0-0.5M. In preferred embodiments, the fraction of alkali hydroxide is controlled such that the pH of electrolyte entering the electrolyzer is between 7-14. In some embodiments, the pH of the electrolyte entering the electrolyzer is between 10-13. In some embodiments, the electrolyte entering the electrolyzer has been previously neutralized using an acid. Thus, in some embodiments, the electrolyte entering the electrolyzer is between 7-8.

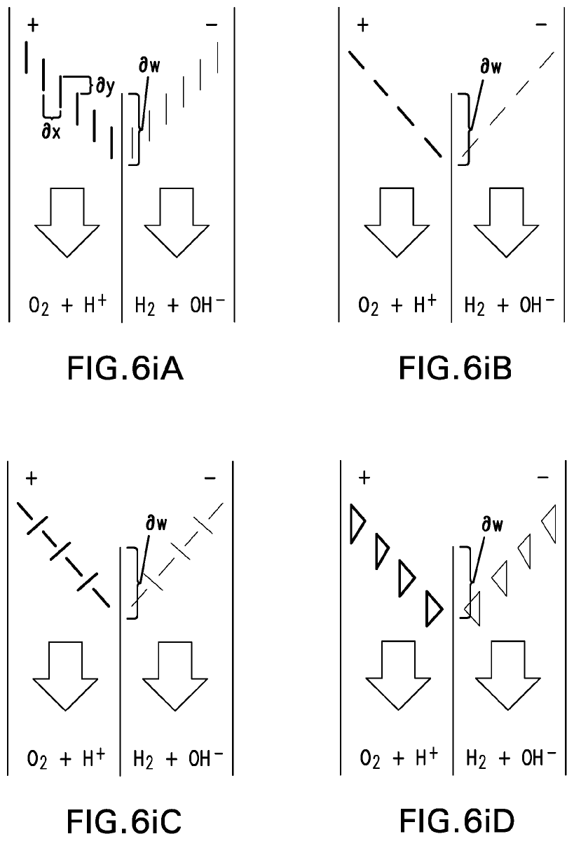

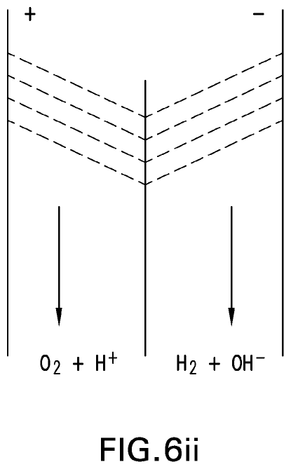

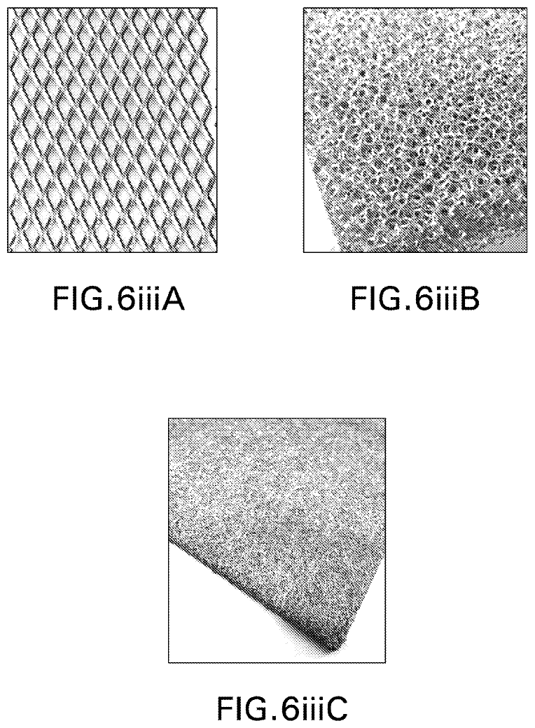

In some embodiments, the membrane-less water electrolyzer is configured such that electrolyte flows by and/or through parallel or non-parallel electrodes spaced apart from one another in at least one dimension. In some embodiments, the membrane-less water electrolyzer is configured with a hybrid configuration such that electrolyte flows through and flows by parallel or non-parallel electrodes where each electrode pair is offset from another electrode pair in at least 1 dimension. In some embodiments, multiple sequential anode/cathode pairs are arranged from upstream to downstream (for example, 2, 3, 4, or 5 or more pairs), such that fluid passes each anode/cathode pair sequentially from a fluid inlet to the acid/base solution outlets. This configuration permits an increase in the conversion rate as water passes through each anode/cathode pair, instead of only one. In some embodiments, evolved H₂ and O₂ gases exit the electrolyzer with the acid/base solutions. In some embodiments, evolved H₂ and O₂ gases segregate from the acid/base solutions and exit through a separate conduit. Embodiments of this electrode architecture are shown in FIG. 6 and discussed in more detail further below.

In some embodiments, an electrolyzer cell is comprised of multiple electrode pairs. In some embodiments, these electrode pairs operate with non-matching potential differences. For example, a first pair of electrodes may operate at a potential difference lower than a second pair of electrodes, and the second pair of electrodes may operate at a potential difference lower than a third pair of electrodes, and so on. In some embodiments, an electrolyzer cell is made of more than one electrode pair operating in parallel. In some embodiments, an electrolyzer stack is made of electrolyzer cells which contain more than one electrode pair per cell.

In some embodiments, the electrodes in the water electrolyzer are constructed from a solid plate, porous plate, porous mesh, solid mesh, solid plate, wire, felt, foam, cylinder, mesh cylinder, or porous cylinder architecture. In some embodiments, the architecture is a combination of these architectures. In some embodiments, the architecture may include nested geometries, e.g., a smaller cylinder inside a larger cylinder. In some embodiments, the architecture may include electrodes with different dimensions, such as a different length or width. In some embodiments, the architecture includes pairs of flow-by plates (for both the anode and cathode) arranged at an offset angle to behave like a flow-through mesh. In some embodiments, each pair of flow by plates (anode/cathode) may have an independently adjustable voltage/potential. In some embodiments, at least one electrode is shaped as a ring, band, wire, disk, or plate.

In preferred embodiments, the water electrolyzer is operated with a pH gradient to produce an acidic solution and basic solution at the anode and cathode, respectively. In some embodiments, the pH gradient ΔpH is 1, 2, 3, 4, 5, 6, 7, 8, 9, 10, 11, 12, 13, 14, 15, or 16. In a preferred embodiment, the pH gradient is 13-16 or more preferably 14-15. In some embodiments, the operating voltage of the electrolyzer and the current density are dynamic and modulated to achieve a desired pH gradient. In particular, the operating voltage and current density may change over time as the ph gradient changes. In some embodiments, the operating voltage of the electrolyzer is between 1.5-5.0 volts. In some embodiments, the operating voltage of the electrolyzer is between 2.0-3.0 volts. In some embodiments, the pH gradient is modulated based on flow rate of water through the electrolyzer. In some embodiments, the flow rates are variable, or flow patterns are modulated to improve cell performance. Without being bound by theory, it is believed inducing turbulence in flow near an electrode surface affects the ionic diffusion layer, surface mixing, ion removal, and bubble removal to improve reaction kinetics. In some embodiments, this permits avoiding the use of platinum-group metals for the electrode materials.

In some embodiments, each electrode pair operates with a single potential difference. In some embodiments, some electrode pairs operate with a single potential difference, while others operate with a different potential difference. In some embodiments, individual electrode pairs may be switched on or off depending on operating conditions inside of the electrolyzer. In some embodiments, electrode pairs may be operated at near-zero voltage (well below the activation potential for water electrolysis), low voltage, voltage below the activation potential for water electrolysis, voltage above the activation potential for water (or far above the activation potential). In some embodiments, pairs of electrodes may be switched off during portions of operation depending on instantaneous operating conditions (water flow rate, pH, pH gradient, temperature, pressure, pressure drop, etc.).

Thus, pairs of electrodes may be activated based on availability of renewable energy. For example, when using a solar array to at least partially power the electrolyzer, electrode pairs operating at lower voltages may be switched on when only a moderate amount of sunshine powers the photovoltaic cells, whereas additional electrode pairs operating at higher voltages may be switched on when a greater amount of sunshine is available. When fewer electrode pairs are switched on, water flow may be limited to ensure production of acids and bases having desired pH. In an alternate embodiment, instead of switching off electrode pairs, all pairs may be operated at a lower voltage. In another embodiment, depending on available power, some electrodes may be switched on at lower voltage, whereas others are switched off completely. As more power becomes available, electrode pairs may be switched on and/or electrode pairs may be operated at a higher voltage. Water flow may be tailored to ensure production of acids and bases having desired pH during such operation. In some embodiments, the water electrolyzer is operated at elevated temperatures, 20-90° C., preferably 30-80° C., or more preferably 40-70° C. In some embodiments, this increases the kinetics of dissolution for less extreme pH gradients, enabling reduction in the operating voltage required to maintain a required pH gradient. In some embodiments, the operation temperature of the water electrolyzer is adjusted based on the pH gradient required to operate the liberation and regeneration vessels. Because ΔpH to operate the liberation and regeneration vessels changes with temperature, the operating temperature of the electrolyzer may be selected to minimize the required ΔpH. In preferred embodiments of the present application, the water electrolyzer operates within the closed loop system for CO₂ capture, avoiding excessive heating and cooling inputs and outputs.

In some embodiments, the electrolyzer comprises a membraneless flow-through/flow-by reactor design. In some embodiments, the electrolyzer comprises a flow-through design, in which water/electrolyte flows through the electrodes. In some embodiments, the electrolyzer comprises a flow-by design, in which water/electrolyte flows by the electrodes. In some embodiments, the electrolyzer comprises a hybrid flow-through/flow by design containing aspects of each. In some embodiments, the membraneless reactor includes an upstream water inlet and two downstream outlets for acidic and basic solutions, respectively. In some embodiments, the membraneless flow-through reactor includes an anode and a cathode arranged obliquely relative to one another in a channel. In some embodiments, the anode and cathode (or anode and cathode pairs) are arranged in parallel rather than obliquely. In some embodiments, the angle between electrodes is defined as angle Θ. In some embodiments, when decreasing the angle between the electrodes, the distance between them also decreases, and as a result the uncompensated solution resistance decreases. In some embodiments, angle is selected from the group consisting of: 180°, 90°, 60°, 45°, 30°, and 0°. In some embodiments, the angle is between 0° and 180°.

2H₂O+2e⁻⇄H₂+2OH⁻ (2)

2H₂O⇄4H⁺+O₂+4e⁻ (3)

In some embodiments, during operation, the products from reactions (2) and (3) are immediately swept downstream of the electrodes, preventing transport and recombination of the H⁺ and OH⁻ ions that would normally occur in a stagnant electrolyte in the absence of a membrane or other means of separating these ions. In some embodiments, by varying operating parameters such as the electric current density of the electrodes, positioning of the electrodes and the flow rate of the electrolyte through the electrolyzer cell, it is possible to produce acid and base at a desired pH. The half-cell reactions (1) and (2) do not show the effect the electrodes have on the electrolyte. For instance, if NaNO₃ is used as the salt, the full electrolytic reaction is shown in reaction (4) below.

6H₂O+4NaNO₃⇄2H₂+O₂+4HNO₃+4NaOH (4)

As indicated previously, embodiments of the water electrolyzer of the present application may be used to supply acids and bases to the direct air capture equipment, systems, and methods of the present application. Thus, in one a preferred embodiment, an acidic solution containing salts produced at the anode may be used in the liberation vessel of the direct air capture system. Likewise, a basic solution containing salts produced at the cathode may be used in the regeneration vessel. The water electrolyzer also produces H₂ and O₂ gas. In some embodiments, the H₂ and O₂ gas are introduced into an energy recovery system as discussed herein. In contrast to other salt-splitting electrolyzers, embodiments of the present application do not produce other gases from corrosion of the electrolyte. For example, water electrolysis in the presence of sodium chloride may produce H₂, O₂, and Cl₂, which may undergo secondary reactions to form HCl.

In some embodiments, a clarification effluent produced from the regeneration vessel, settling tank, and/or the de-watering step may optionally be recycled to the electrolyzer. Thus, in some embodiments, the clarification effluent is fed to an inlet in the electrolyzer. In some embodiments, the clarification effluent contains water and electrolyte and is weakly basic. In some embodiments, the clarification effluent has a pH between 7-14, 10-13, or 7-8. In some embodiments, the clarification effluent may be exposed to air during recycling to absorb CO₂. In certain embodiments, the effluent containing absorbed CO₂ is mixed with carbonated metal hydroxides to increase the extent of carbonation in a treatment step before carbonate solids enter the liberation vessel. In certain embodiments, the CO₂ captured using the effluent is mixed with carbonated metal hydroxides to increase the extent of carbonation in a treatment step before carbonate solids enter the liberation vessel. In some embodiments, the otherwise sourced CO₂ is mixed with carbonated metal hydroxides to increase the extent of carbonation in a treatment step before carbonate solids enter the liberation vessel. In some embodiments, the clarification effluent may be used as general feedwater to the electrolyzer. In some embodiments, the clarification effluent may be filtered of particles and used as general feedwater to the electrolyzer.

In some embodiments, the clarification effluent is treated with a water softening process to reduce alkalinity before being reused as feedwater to the electrolyzer. In some embodiments, alkalinity reduction includes ion exchange processes to remove metal ions, e.g., Ca²⁺ ions, which can prevent metal hydroxide precipitation on the electrolyzer's cathode, e.g., calcium hydroxide precipitation. In some embodiments, the ion exchange equipment is regenerated by flushing with electrolyte to recover Ca²⁺ ions for continued use in the CO₂ capture process. In some embodiments, the basic clarification effluent is treated through a neutralization step, using acid produced by the electrolyzer, in order to reduce the overall pH before entering the electrolyzer.

In some embodiments, the water electrolyzer is configured as a cell stack comprising a plurality of cells, which may also be called an electrolyzer stack. Each cell in the stack may contain multiple electrode pairs as discussed previously. It shall be understood that the present application encompasses single and multiple cell electrolyzer designs. In some embodiments, the electrolyzer or electrolyzer stack contains the liberation and regeneration vessels. In some embodiments, the liberation and regeneration vessels contain the electrolyzer or electrolyzer stack. In a preferred embodiment, such an electrolyzer is operated using an electrolyte. In a preferred embodiment, the electrolyte is NaNO₃ and water. In a preferred embodiment, the electrolyzer or electrolyzer stack is operated at elevated temperature. In some embodiments, the electrolyzer is operated at a temperature between 20-90° C., preferably 30-80° C., or more preferably 40-70° C.

In one embodiment, the metal carbonate produced in the metal hydroxide carbonation racks, preferably CaCO₃, is introduced into the electrolyzer. In some embodiments, the metal carbonate is introduced into the electrolyzer proximate to the anode. In some embodiments, an acidic solution is present proximate to the anode and a basic solution is present proximate to the cathode due to the potential applied across the anode and cathode. Thus, in some embodiments, the electrolyzer liberates CO₂ and O₂ gas at the anode and produces an alkaline solution containing metal ions (e.g., Ca²⁺). In some embodiments, electrodialysis is used to move the metal ions towards a cathode. Such electrodialysis reduces the amount of unnecessary acid-base neutralization. Thus, the cathode liberates H₂ gas and produces a metal hydroxide (e.g., Ca(OH)₂) precipitate. Accordingly, in some embodiments, CO₂ and O₂ are produced in a first gas stream and H₂ is produced in a second gas stream. The first and second gas streams are introduced into an energy recovery system as discussed herein to obtain CO₂ and H₂O, which may be separated by cooling, condensing, and/or dehydration processes.

In some embodiments, a fraction of H₂ and O₂ produced from the electrolyzer is stored (rather than directed immediately to the energy recovery system) to temporally shift the energy recovery process to generate electricity and maintain process power and continuity in subsystems, including particle suspension pumping and stirring, or to maintain electrolysis continuity.

### Metal Hydroxide Powder Processing

In embodiments discussed herein, a metal hydroxide powder is obtained from a regeneration vessel. In further embodiments, the metal hydroxide powder is used to form pellets of metal hydroxide which are usable in the metal hydroxide carbonation racks or vessel discussed above. In some embodiments, waste heat produced in the liberation vessel or energy recovery system may be used for partial drying of metal hydroxide, for maintaining temperature in the regeneration vessel, or for warming feedstock for the water electrolyzer. In some embodiments, water is evaporated from the pellets (e.g., by flowing air over the pellets, or reducing pressure, to increase water evaporation while they are at elevated temperature), and subsequently condensed (e.g., from the flowing air stream) for recovery for re-use, for example in the water electrolyzer.

In some embodiments, a metal hydroxide powder is obtained from a settling tank. In further embodiments, the metal hydroxide powder is composed of agglomerated sub-micron Ca(OH)₂ particles. In some embodiments, the agglomerated Ca(OH)₂ powder is fully saturated with water. In further embodiments, the water saturating the metal hydroxide powder contains NaNO₃ at concentrations between 0.01M and fully saturated concentrations. In further embodiments, the water saturating the metal hydroxide powder has a pH between 9 and 14 and contains alkali hydroxide, for example NaOH. In some embodiments, the concentration of alkali hydroxide is 0.00001-1M.

In further embodiments, the metal hydroxide powder is a slurry, paste, or particle suspension with water and other ions. In some embodiments, the metal hydroxide-water mixture is pumped from the settling tank, preferably the bottom. In some embodiments, the solid volume of metal hydroxide particles in the wet mixture is 10-50% by volume of the pumped mixture, or preferably 25-35% by volume.

In some embodiments, the metal hydroxide slurry, paste, or particle suspension is extruded. In some embodiments, the metal hydroxide slurry, paste, or particle suspension is further de-watered before extrusion. In further embodiments, inert particles are added to the metal hydroxide slurry, paste, or particle suspension before extrusion. In some embodiments, the addition of inert particles increases the solid volume fraction and improves pellet stability (e.g., prevents cracking upon drying, improves extrusion and lessens deformation, etc.). In some embodiments, pellets may be formed by coating inert particles.

### Energy Recovery

Some embodiments of the present application include an energy recovery system. In preferred embodiments, H₂ and O₂ produced in the electrolyzer are consumed by the energy recovery system including a hydrogen-oxygen fuel cell or a combustion chamber/turbine for the same purpose. It should be understood that multiple fuel cells, combustion chambers, and/or turbines, and/or combustion cycles may be used. In some embodiments, the energy recovery system is used to separate CO₂ and O₂ produced in the liberation vessel. In some embodiments, the energy recovery system is used to separate CO₂ and H₂O produced in the energy recovery system. In some embodiments, liberated CO₂ or a CO₂/H₂O mixture may be used as a diluent gas for H₂ combustion to reduce flame temperature.

In a preferred embodiment, the energy produced in the energy recovery system is directed to electrolysis to reduce external energy demand. In some embodiments, waste heat produced in the energy recovery system is used to heat other processes (e.g., the regeneration vessel, or electrolyzer feedwater).

In some embodiments, heat is transferred from one location or subsystem to heat other processes (e.g., the regeneration vessel, or electrolyzer feedwater). In some embodiments, heat transfer occurs with a heat exchanger. In some embodiments, heat transfer occurs with a heat pump.

### Figures

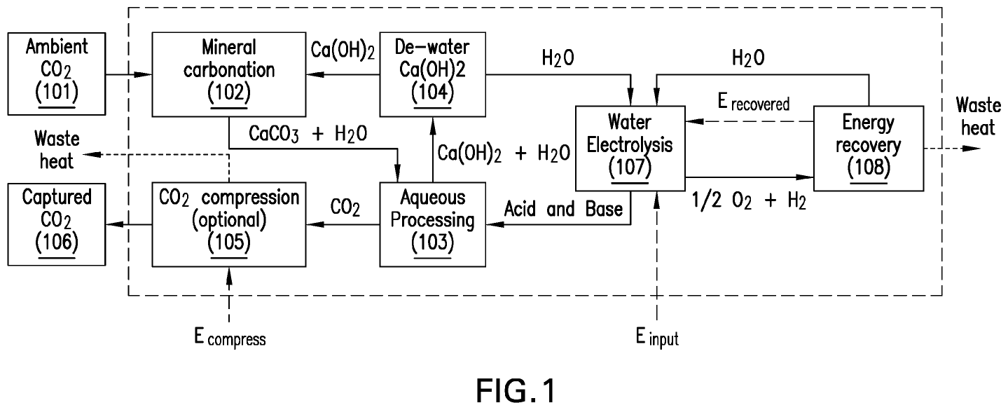

FIG. 1 depicts an embodiment of the process flow diagram of a system and method of the present application.

A gas stream (101) depicted as ambient air containing CO₂ is passed into step (102) for capturing CO₂. In step (102), Ca(OH)₂ (optionally arranged as pellets in a plurality of trays) is reacted with the gas stream (101) under reaction (Ca(OH)₂+CO₂→CaCO₃+H₂O), producing carbonate and removing the carbon dioxide from the gas stream (101). A purified gas stream (not depicted) having a lower concentration of carbon dioxide exits step (102). In some embodiments, the purified gas stream may be passed through step (102) again to remove further CO₂ until a desired concentration of CO₂ in the purified gas stream is reached.

The mineral carbonation reaction products (102) are then fed into step (103) for a 2-step aqueous processing including the liberation of CO₂ and the regeneration of Ca(OH)₂ particles. In step (103), the products of (102) are first exposed to a concentrated acid and undergo an reaction (CaCO₃+2HNO₃→H₂O+Ca²⁺+CO₂+2NO₃⁻) and then exposed to a concentrated base, undergoing an reaction (Ca²⁺+2NO₃⁻+2NaOH→Ca(OH)₂+2NaNO₃). The CO₂ evolved during the acidic dissolution of CaCO₃ in (103) exits the liberation vessel and is optionally compressed (105) before the final captured CO₂ product (106) is provided for use or storage. The regenerated product Ca(OH)₂ precipitated in basic conditions in (103) is dewatered (104) and the resulting Ca(OH)₂ is recovered and used again as a reactant in step (102). The water is recovered from step (104) is recycled through the process and used as the fluid medium for acid and base production in step (107) before returning to step (103).

The concentrated acids and based fed into the aqueous processing step (103) are obtained through water electrolysis (107), where water and an electrolyte (NaNO₃ for this example) undergo an electrochemical reaction (3H₂O+2NaNO₃→H₂+½O₂+2NaOH+2HNO₃). Power for step (107) is supplied as electricity, preferably from renewable power sources. The products H₂+(½)O₂ are then fed into step (108) for energy recovery. In step (108), such products undergo an exothermic reaction (H₂+½O₂→H₂O) producing water and heat or power. Recovered electricity from step (108) may be used in step (107) to reduce the external power requirements. Waste heat produced in steps (105) and (108) may be used for dewatering or for other uses.

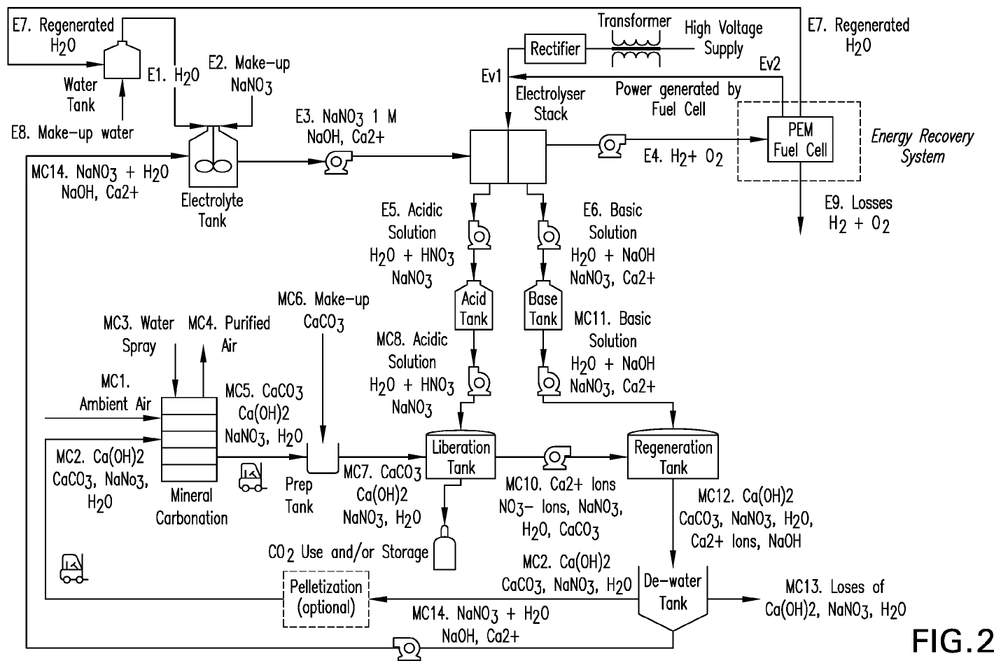

FIG. 2 depicts an embodiment of a process flow diagram of a system and method of the present application.

Ambient air (MC1) is passed into or through a mineral carbonation rack or vessel. Ca(OH)₂ is added to a mineral carbonation rack, optionally with NaNO₃ and H₂O. Once prepared, Ca(OH)₂+NaNO₃+H₂O composition (MC2), optionally in the form of pellets, is added to a plurality of mineral carbonation racks. The ambient air (MC1) reacts with composition (MC2) to generate CaCO₃ and purified air (MC4). The purified air (MC4) exits the mineral carbonation racks.

A composition (MC5) containing CaCO₃+Ca(OH)₂+NaNO₃+H₂O is removed from the mineral carbonation rack or vessel, mixed with make-up CaCO₃ for mass balance purpose (MC6), and is introduced into a liberation vessel. An acidic solution (MC8) containing H₂O, HNO₃, and NaNO₃ is added to the liberation vessel. As a result, the liberation vessel liberates CO₂ stream (MC9). The CO₂ stream (MC9) is diverted for use and/or storage, and is optionally compressed.

An alkaline solution (MC10) of Ca²⁺ ions, NaNO₃, H₂O, and optionally Ca(OH)₂ is pumped into a regeneration vessel. A basic solution (MC11) containing H₂O, NaOH, and NaNO₃ is added to the regeneration vessel. The regeneration vessel precipitates Ca(OH)₂. The products (MC12) containing Ca(OH)₂+NaNO₃+H₂O are passed to a de-watering/drying vessel or tank. The dewatered products (MC2) are optionally pelletized before being returned for mineral preparation and use in the mineral carbonation rack. Embodiment shows a forklift transporting the minerals from the de-water tank to the mineral carbonation racks, but this can be substituted by other manual or automated systems. A solution (MC14) of NaNO₃+H₂O is returned to an electrolyte tank for use in the water electrolyzer stack.

Water (E1) from a water tank and NaNO₃ (E2) are added to the electrolyte tank (along with the solution (MC14) returned from the de-watering step). An electrolyte solution (E3) is pumped and added to an electrolyzer stack. The electrolyzer stack is operated with a pH gradient and produces acidic solution (E5) and basic solution (E6) referred to above, which are pumped from the electrolyzer stack to their respective destinations shown in FIG. 2. The H₂ and O₂ products (E4) from the electrolyzer are pumped to the energy recovery system.

The energy recovery system in FIG. 2 is embodied as a fuel cell system, but a combustion system is also contemplated. The H₂ and O₂ products (E4) from the electrolyzer enter the fuel cell and generate electricity and water. The regenerated water (E7) is fed to the water tank for use in the water electrolyzer. The energy produced in the energy recovery system is optionally utilized to run the electrolyzer.

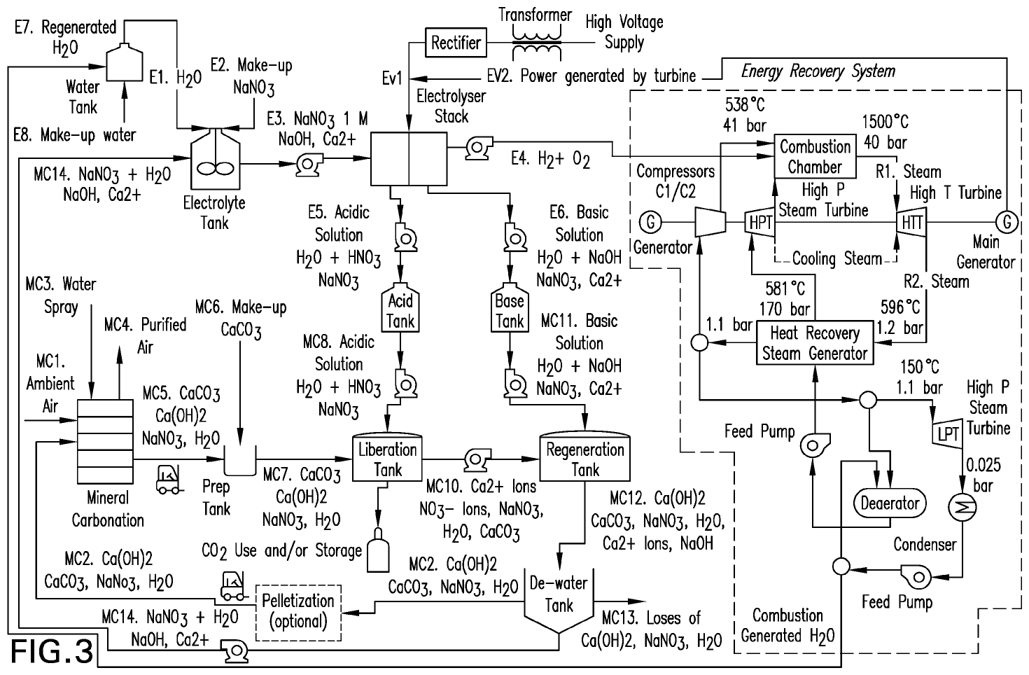

FIG. 3 depicts another embodiment of a process flow diagram of a system and method of the present application.

Ambient air (MC1) is passed into or through a mineral carbonation rack or vessel. Ca(OH)₂ is added to a mineral carbonation rack, optionally with NaNO₃ and H₂O. Once prepared, Ca(OH)₂+NaNO₃+H₂O composition (MC2), optionally in the form of pellets, is added to a plurality of mineral carbonation racks. The ambient air (MC1) reacts with composition (MC2) to generate CaCO₃ and purified air (MC4). The purified air (MC4) exits the mineral carbonation racks.

A composition (MC5) containing CaCO₃+Ca(OH)₂+NaNO₃+H₂O is removed from the mineral carbonation rack or vessel, mixed with make-up CaCO₃ for mass balance purpose (MC6), and is introduced into a liberation vessel. An acidic solution (MC8) containing H₂O, HNO₃, and NaNO₃ is added to the liberation vessel. As a result, the liberation vessel liberates CO₂ stream (MC9). The CO₂ stream (MC9) is diverted for use and/or storage, and is optionally compressed.

An alkaline solution (MC10) of Ca²⁺ ions, NaNO₃, H₂O, and optionally Ca(OH)₂ is pumped into a regeneration vessel. A basic solution (MC11) containing H₂O, NaOH, and NaNO₃ is added to the regeneration vessel. The regeneration vessel precipitates Ca(OH)₂. The products (MC12) containing Ca(OH)₂+NaNO₃+H₂O are passed to a de-watering/drying vessel or tank. The dewatered products (MC2) are optionally pelletized before being returned for mineral preparation and use in the mineral carbonation rack. Embodiment shows a forklift to transport the minerals from the de-water tank to the mineral carbonation racks, but this can be substituted by an automatized system. A solution (MC14) of NaNO₃+H₂O is returned to an electrolyte tank for use in the water electrolyzer stack.

Water (E1) from a water tank and NaNO₃ (E2) are added to the electrolyte tank (along with the solution (MC14) returned from the de-watering step). An electrolyte solution (E3) is pumped and added to an electrolyzer stack. The electrolyzer stack is operated with a pH gradient and produces acidic solution (E5) and basic solution (E6) referred to above, which are pumped from the electrolyzer stack to their respective destinations shown in FIG. 3. The H₂ and O₂ products (E4) from the electrolyzer are pumped to the energy recovery system.

The energy recovery system in FIG. 3 is embodied as a combustion system, but a fuel cell system is also contemplated. The H₂ and O₂ products (E4) from the electrolyzer enter a combustion chamber and are combusted at 538° C. and 41 bar (from compressors C1/C2). The steam combustion product (R1) (1500° C., 40 bar) drives High T turbine (HTT), which in turn drives main generator (G), generator (G), and compressors C1/C2. The steam product (R2) (596° C., 1.2 bar) exiting High T turbine (HTT) enters the Heat Recovery Steam Generator. A flow of steam at 581° C. and 170 bar drives High P turbine (HPT), which in turn drives main generator (G), generator (G), and compressors C1/C2. A flow of steam at 1.1 bar is split, a part of which enters compressors C1/C2. Another part enters Low P Steam Turbine (LPT), a condenser to produce water, and then a water feed pump. The water produced is delivered to the water tank for use in the electrolyzer and is mixed with de-aerated steam and pumped into the Heat Recovery Steam Generator.

The energy produced in the energy recovery system is optionally utilized to run the electrolyzer.

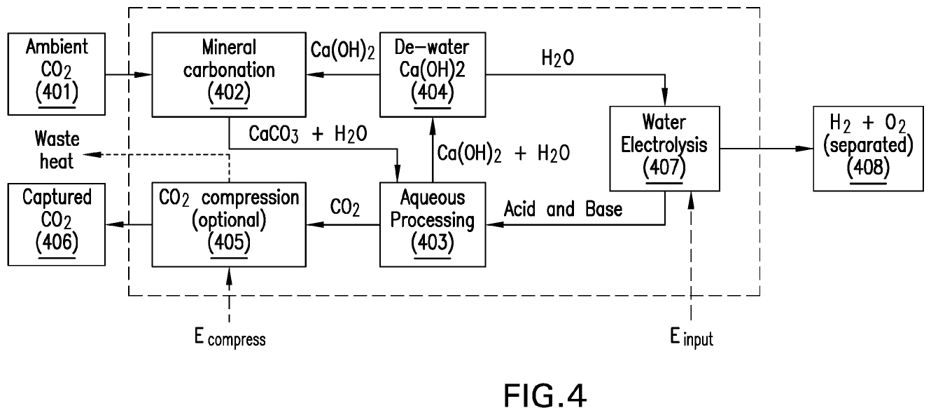

FIG. 4 depicts an embodiment of the process flow diagram of a system and method of the present application.

A gas stream (401) depicted as ambient air containing CO₂ is passed into step (402) for capturing CO₂. In step (402), Ca(OH)₂ (optionally arranged as pellets in a plurality of trays) is reacted with the gas stream (401) under reaction (Ca(OH)₂+CO₂→CaCO₃+H₂O), producing carbonate and removing the carbon dioxide from the gas stream (401). A purified gas stream (not depicted) having a lower concentration of carbon dioxide exits step (402). In some embodiments, the purified gas stream may be passed through step (402) again to remove further CO₂ until a desired concentration of CO₂ in the purified gas stream is reached.

The mineral carbonation reaction products (402) are then fed into step (403) for a 2-step aqueous processing including the liberation of CO₂ and the regeneration of Ca(OH)₂ particles. In step (403), the products of (402) are first exposed to a concentrated acid and undergo an reaction (CaCO₃+2HNO₃→H₂O+Ca²⁺+CO₂+2NO₃⁻) and then exposed to a concentrated base, undergoing an reaction (Ca²⁺+2NO₃⁻+2NaOH→Ca(OH)₂+2NaNO₃). The CO₂ evolved during the acidic dissolution of CaCO₃ in (403) exits the liberation vessel and is optionally compressed (405) before the final captured CO₂ product (406) is provided for use or storage. The regenerated product Ca(OH)₂ precipitated in basic conditions in (403) is dewatered (404) and the resulting Ca(OH)₂ is recovered and used again as a reactant in step (402). The water is recovered from step (404) is recycled through the process and used as the fluid medium for acid and base production in step (407) before returning to step (403). Waste heat produced in steps (405) may be used for dewatering or for other uses.

The concentrated acids and based fed into the aqueous processing step (403) are obtained through water electrolysis (407), where water and an electrolyte (NaNO₃ for this example) undergo an electrochemical reaction (3H₂O+2NaNO₃→H₂+½O₂+2NaOH+2HNO₃). Power for step (407) is supplied as electricity, preferably from renewable power sources. The products of (407) (H₂+(½)O₂) are then provided as separate gases for commercial or industrial uses.

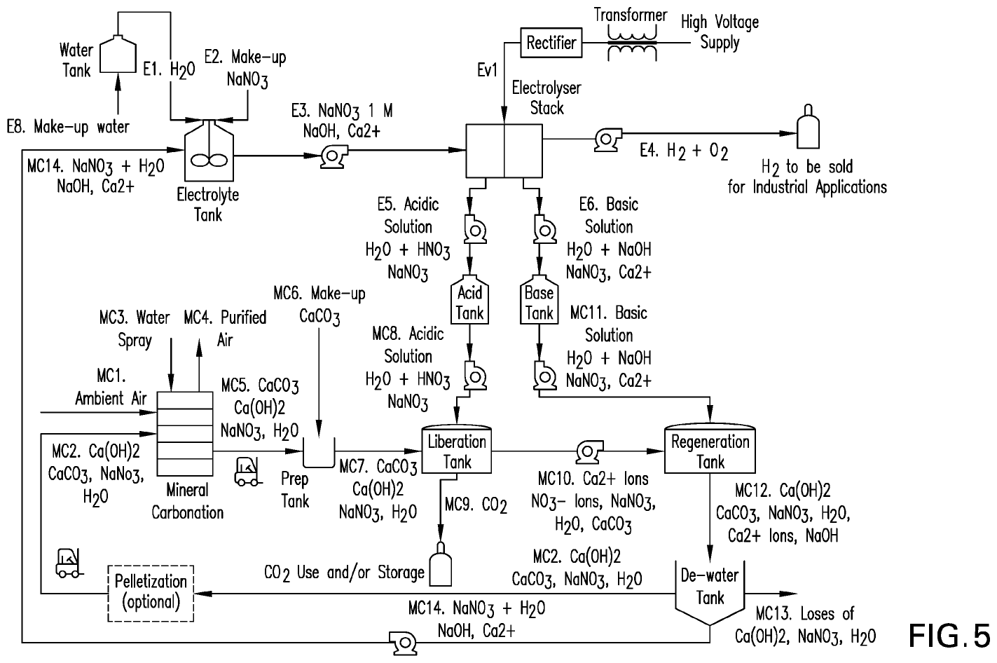

FIG. 5 depicts an embodiment of a process flow diagram of a system and method of the present application.

Ambient air (MC1) is passed into or through a mineral carbonation rack or vessel. Ca(OH)₂ is added to a mineral carbonation rack, optionally with NaNO₃ and H₂O. Once prepared, Ca(OH)₂+NaNO₃+H₂O composition (MC2), optionally in the form of pellets, is added to a plurality of mineral carbonation racks. The ambient air (MC1) reacts with composition (MC2) to generate CaCO₃ and purified air (MC4). The purified air (MC4) exits the mineral carbonation racks.

A composition (MC5) containing CaCO₃+Ca(OH)₂+NaNO₃+H₂O is removed from the mineral carbonation rack or vessel, mixed with make-up CaCO₃ for mass balance purpose (MC6), and is introduced into a liberation vessel. An acidic solution (MC8) containing H₂O, H⁺, NO₃⁻, and NaNO₃ is added to the liberation vessel. As a result, the liberation vessel liberates CO₂ stream (MC9). The CO₂ stream (MC9) is diverted for use and/or storage, and is optionally compressed.

An alkaline solution (MC10) of Ca²⁺ ions, NaNO₃, H₂O, and optionally Ca(OH)₂ is pumped into a regeneration vessel. A basic solution (MC11) containing H₂O, OH⁻, Na⁺, and NaNO₃ is added to the regeneration vessel. The regeneration vessel precipitates Ca(OH)₂. The products (MC12) containing Ca(OH)₂+NaNO₃+H₂O are passed to a de-watering/drying vessel or tank. The heat from the dewatered products (16) Ca(OH)₂+NaNO₃+H₂O is captured for re-use as discussed in embodiments herein. The dewatered products (MC2) are optionally pelletized before being returned for mineral preparation and use in the mineral carbonation rack. Embodiment shows a forklift to transport the minerals from the de-water tank to the mineral carbonation racks, but this can be substituted by an automatized system. A solution (MC14) of NaNO₃+H₂O is returned to an electrolyte tank for use in the water electrolyzer stack.

Water (E1) from a water tank and NaNO₃ (E2) are added to the electrolyte tank (along with the solution (MC14) returned from the de-watering step). An electrolyte solution (E3) is pumped, heated to 80° C., and added to an electrolyzer stack. The electrolyzer stack is operated with a pH gradient and produces acidic solution (E5) and basic solution (E6) referred to above, which are pumped from the electrolyzer stack to their respective destinations shown in FIG. 5. The H₂ product (E4) from the electrolyzer is provided for commercial or industrial applications including ammonia production, methanol production, direct reduction of iron for steel, other chemical processing operations, etc.

FIG. 6 depicts embodiments of several electrode architectures in a membraneless, flow-by/flow-through electrolyzer, including the addition of several electrode pairs, as well as an exemplification of electrodes that would be used. FIG. 6.i depicts embodiments of different electrode architectures in a membraneless flow-through electrolyzer.

FIG. 6.i.A depicts a plate architecture wherein each plate associated with a particular electrode (the anode and cathode are designated by “+” and “−”) is arranged parallel and offset in directions ∂x, ∂y with relation to the other plates. In the alternative, a mesh electrode may be used.

FIG. 6.i.B depicts an alternative architecture wherein each plate is arranged in parallel and is collinear with the other plates. The plates in FIG. 6.i.B are separated by gaps as depicted. In the alternative, a mesh electrode may be used.

FIG. 6.i.C depicts an alternative architecture wherein a first plurality of plates are arranged in parallel and are collinear with the other plates of the first plurality, and a second plurality of plates are arranged in parallel with the other plates of the second plurality but are offset in directions ∂x, ∂y. In an alternative embodiment, the first and second pluralities of plates could form a step-like pattern. In the alternative, a mesh electrode may be used.

FIG. 6.i.D depicts an alternative embodiment similar to the embodiment shown in FIG. 6.i.B, wherein a solid or hollow region is arranged behind each plate such that fluid flow through the plates is more laminar or less turbulent as it passes through the plurality of plates. In all architectures, the solid barrier that divides each electrode chamber could have a different height ∂w that would have an effect on the overall resistance of the cell, as well as in the possibility of mixing of products after electrolysis has occurred. This height ∂w will be defined depending on the characteristics of the electrodes used.

FIG. 6.ii depicts multiple sequential anode/cathode pairs that are arranged from upstream to downstream. In the embodiment depicted, layers of pairs are sequentially arranged, with each layer containing multiple pairs (4 layers are shown), such that fluid passes each anode/cathode pair sequentially from a fluid inlet to the acid/basic solution outlets. Alternatively, this embodiment comprises a plurality of layers, each layer comprising a plurality of electrodes. The image depicts the architecture corresponding to FIG. 6.i.B, but this configuration will be also applied to the other proposed architectures.

FIG. 6.iii shows examples of different electrodes that could be used in a membraneless flow-through electrolyzer. In the embodiment shown in FIG. 6.iii.A, a diamond mesh electrode is used, although other mesh shapes/patterns are possible. In the embodiment shown in FIG. 6.iii.B, a foam electrode is used. In the embodiment shown in FIG. 6.iii.C, a felt electrode is used. In embodiments of the present application, the electrodes may be constructed of typical electrode materials.

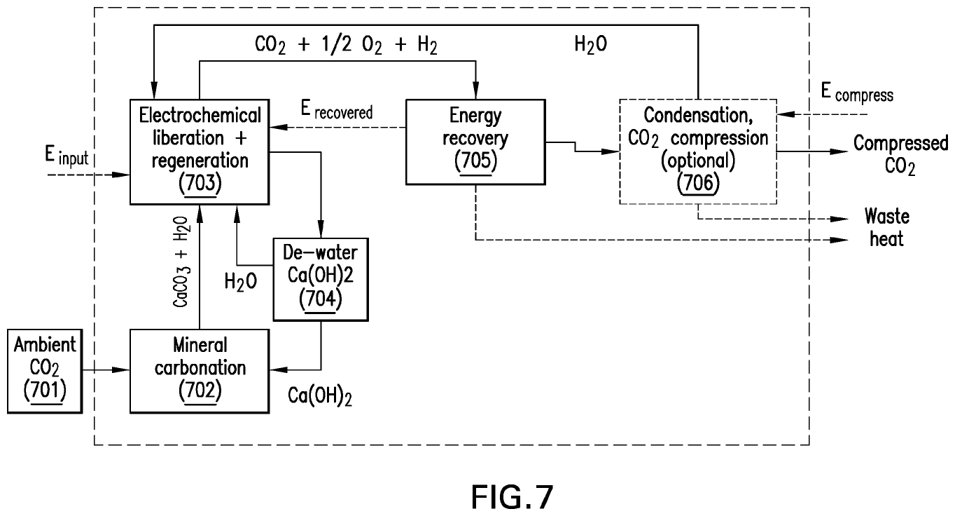

FIG. 7 depicts an additional embodiment of process flow diagram of a system and method of the present application.

A gas stream (701) depicted as ambient air containing CO₂ is passed into step (702) for capturing CO₂. In step (702), Ca(OH)₂ (optionally arranged as pellets in a plurality of trays) is reacted with the gas stream (701) under reaction Rxn 3 (Ca(OH)₂+CO₂→CaCO₃+H₂O), producing carbonate and removing the carbon dioxide from the gas stream (701). A purified gas stream (not depicted) with having a lower concentration of carbon dioxide exits step (702). In some embodiments, the purified gas stream may be passed through step (702) again to remove further CO₂ until a desired concentration of CO₂ in the purified gas stream is reached.

The reaction products step (702) are then fed into step (703) for electrochemical liberation and regeneration. In step (703), such products undergo Rxn 1 (CaCO₃+2H₂O→Ca(OH)₂+CO₂+H₂+½O₂). The product Ca(OH)₂ is dewatered (704) and the resulting Ca(OH)₂ is recovered and used again as a reactant step (702). The water is recovered and used again as a reactant in step (703).

The products CO₂+H₂+(½)O₂ are then fed into step (705) for energy recovery. In step (705), such products undergo exothermic reaction Rxn 2 (H₂+½O₂→H₂O) producing water. The water and CO₂ are then fed into step (706) for condensation to separate the water and CO₂ and optional compression of the CO₂ gas. Waste heat produced in steps (705) and (706) may be used for dewatering or for other uses.

### Further Embodiments

A-1. A system for capturing atmospheric carbon dioxide, comprising: a mineral carbonation rack containing a metal hydroxide for capturing carbon dioxide by converting the metal hydroxide to metal carbonate;
a liberation vessel for liberating carbon dioxide from the metal carbonate;
a regeneration vessel for regenerating metal hydroxide;
a water electrolyzer for producing an acid and base for use in the liberation vessel and the regeneration vessel; and
an energy recovery system for providing energy to the water electrolyzer;
wherein the liberation vessel, regeneration vessel, and water electrolyzer are all operated at a temperature from 20-90° C., preferably 30-80° C., or more preferably 40-70° C.

A-2. The system of A-1,
wherein the metal hydroxide is crystalline, non-crystalline, or amorphous and is selected from the group consisting of (i) alkaline earth hydroxides, preferably calcium hydroxide, calcium magnesium hydroxide, magnesium hydroxide, (ii) calcium silicate hydrates, including tobermorite, afwillite, jennite, and xonotlite, (iii) magnesium carbonate hydrates, including magnesium carbonate hydroxide, dypingite, artinite, lansfordite, hydromagnesite, nesquehonite, barringtonite, (iv) magnesium silicate hydrates, including lizardite, serpentine, talc, antigorite, and (v) mixtures thereof.

A-3. The system of A-2,
wherein the metal hydroxide is calcium hydroxide.

A-4. The system of any of A-1 to A-3,
wherein the metal hydroxide in the mineral carbonation rack is composed of pellets.

A-5. The system of any of A-1 to A-4,
wherein the liberation vessel comprises
an opening for receiving a metal carbonate produced in the mineral carbonation rack; and an inlet for an acidic solution produced by the water electrolyzer, for dissolving the metal carbonate to produce a pure carbon dioxide gas and metal ion solution.

A-6. The system of any of A-1 to A-5,
wherein the regeneration vessel comprises
an inlet for receiving a metal ion solution; and
an inlet for receiving a basic solution produced by the water electrolyzer, for precipitating a metal carbonate from the metal ion solution.

A-7. The system of any of A-1 to A-6,
wherein the water electrolyzer is a membraneless, flow through water electrolyzer operated at a pH gradient.

A-8. The system of A-7,
wherein the pH gradient is 6-10, preferably 7-9.

A-9. The system of any of A-1 to A-8,
wherein the mineral carbonation rack, liberation vessel, regeneration vessel, and water electrolyzer are operated with the same salt.

A-10. The system of A-9,
wherein the salt is selected from the group consisting of sodium nitrate, potassium nitrate, sodium chloride, potassium chloride, sodium carbonate, potassium carbonate, sodium iodide, potassium iodide, magnesium chloride, calcium chloride, magnesium nitrate, calcium nitrate, and combinations or mixtures thereof.

A-11. The system of A-10,
wherein the salt is sodium nitrate.

A-12. The system of A-1,
wherein the energy recovery system comprises a fuel cell, combustion chambers, turbines, and/or combustion cycles.

A-13. The system of A-12,
wherein energy generated by the energy recovery system is used to power the water electrolyzer.

B-1. A method of capturing carbon dioxide from the atmosphere, comprising: providing a system according to any of A-1 to A-13;
passing an air stream containing carbon dioxide into the mineral carbonation rack to convert a metal hydroxide into a metal carbonate;
dissolving a metal carbonate in the liberation vessel to liberate a pure carbon dioxide stream; diverting the pure carbon dioxide stream for further processing, use, or storage.

C-1. A direct air capture system comprising:
a wet mixture of metal hydroxide and salt.

C-2. The direct air capture system of C-1,
wherein the metal hydroxide is calcium hydroxide.

C-3. The direct air capture system of C-1,
wherein the metal hydroxide is crystalline, non-crystalline, or amorphous and is selected from the group consisting of (i) alkaline earth hydroxides, preferably calcium hydroxide, calcium magnesium hydroxide, magnesium hydroxide, (ii) calcium silicate hydrates, including tobermorite, afwillite, jennite, and xonotlite, (iii) magnesium carbonate hydrates, including magnesium carbonate hydroxide, dypingite, artinite, lansfordite, hydromagnesite, nesquehonite, barringtonite, (iv) magnesium silicate hydrates, including lizardite, serpentine, talc, antigorite, and (v) mixtures thereof.

C-4. The direct air capture system of C-1,
wherein the salt is a hygroscopic salt which may be mixed with a fraction of an alkali metal hydroxide.

C-5. The direct air capture system of C-1 to C-4, further comprising:
vertically stacked trays containing pellets comprising the wet mixture of metal hydroxide and salt.

C-6. The direct air capture system of C-1 to C-5, further comprising:
a sprayer, mister, or applicator configured to apply water to the wet mixture of metal hydroxide and salt.

C-7. The direct air capture system of C-1 to C-6,
wherein the wet mixture of metal hydroxide is comprised of particles having a mean diffusion distance under 10 mm.

C-8. The direct air capture system of C-1 to C-7,
wherein the wet mixture of metal hydroxide further comprises an inert material.

C-9. The direct air capture system of C-1 to C-8, further comprising:
carbonation racks comprising trays of pellets, the pellets comprising the wet mixture of metal hydroxide and salt, wherein the carbonation racks support and provide ballast for photovoltaic panels.

D-1. A sorbent processing system for carbon dioxide liberation and metal hydroxide regeneration comprising:
a liberation vessel comprising an acidic solution for dissolving metal carbonates to produce CO₂ and metal ions, wherein the acidic solution has a temperature of 20-90° C., preferably 30-80° C., or most preferably 40-70° C. and a salt concentration of at least 0.01M.

D-2. The sorbent processing system of claim D-1, further comprising:
a regeneration vessel comprising a basic solution for precipitating metal hydroxide particles from metal ions, wherein the basic solution has a temperature of 20-90° C., preferably 30-80° C., or most preferably 40-70° C. and a salt concentration of at least 0.01M.

D-3. The sorbent processing system of claims D-1 to D-2, further comprising:
a solids separation tank, wherein the solids separation tank utilizes a centrifuge, precipitation, coagulation floatation, flocculation, spray drying, pellet reactor, sieving, filtration, or another similar method of solids-liquid separation.

D-4. The sorbent processing system of D-1 to D-3,
wherein the metal carbonate is calcium carbonate.

D-5. The sorbent processing system of D-1 to D-4,
wherein the regeneration vessel further comprises a stirrer or shearer.

D-6. The sorbent processing system of D-2 to D-5,
wherein the metal hydroxide particles precipitated have a particle size of less than 1 micron.

D-7. The sorbent processing system of D-2 to D-6,
wherein the metal carbonates are sourced from the direct air capture system of claims 1-8.

D-8. The sorbent processing system of D-2 to D-7, further comprising:
wherein the solids separation tank is configured to separation metal hydroxide particles for pellet formation for use in the carbonation racks

D-9. The sorbent processing system of D-2 to D-8, further comprising:
a pre-treatment tank for exposing sorbent or partially reacted sorbent to CO₂ prior to entering the liberation vessel.

D-10. The sorbent processing system of D-2 to D-9,
wherein the liberation vessel or a tank upstream or downstream of the liberation vessel further comprises an inert solids separator selected from the group consisting of a surface skimmer, a bottom rake, a pump, a filter, or a belt filter press.

D-11. The sorbent processing system of D-2 to D-10,
wherein a tank downstream of the liberation vessel and upstream of the regeneration vessel further comprises an inert solids separator selected from the group consisting of a sedimentation tank.

E-1. A water electrolyzer comprising:
a plurality of anode/cathode pairs,
an inlet configured to flow electrolyte to the plurality of anode/cathode pairs,
an acid solution channel and outlet,
a basic solution channel and outlet,
a divider between the acid solution channel and the basic solution channel,
wherein there is no membrane or divider between the anode and cathode of each anode/cathode pair.

E-2. The water electrolyzer of E-1, further comprising:
a hydrogen outlet and an oxygen outlet.

E-3. The water electrolyzer of E-1 to E-1, further comprising:
an electrolyte solution, wherein the electrolyte has a pH between 7-14.

E-4. The water electrolyzer of E-1 to E-3,
wherein the inlet is fluidly connected to a source of water containing electrolyte having a pH between 7-14.

E-5. The water electrolyzer of E-1 to E-4,
wherein the inlet is fluidly connected to a coagulation or settling tank and is configured to draw solution from said coagulation or settling tank and deliver it to the electrolyzer.

E-6. The water electrolyzer of E-1 to E-5,
wherein a water softening or treatment tank is provided between the inlet and the coagulation or settling tank.

E-7. The water electrolyzer of E-1 to E-6,
wherein the fluid in the electrolyzer has a temperature of 20-90° C., preferably 30-80° C., or more preferably 40-70° C.

E-8. The water electrolyzer of E-1 to E-7,
wherein the anode/cathode pairs are electrodes comprising a geometry selected from the group consisting of flow-through and flow-by meshes, plates, foams, and other materials arranged at an offset angle with respect to adjacent electrodes.

E-9. The water electrolyzer of E-1 to E-8,
wherein the anode/cathode pairs are spatially arranged in the direction of fluid flow through the water electrolyzer such that each successive pair is arranged downstream of a prior pair.

E-10. The water electrolyzer of E-1 to E-9,
wherein each electrode comprises a sheet, plate, wire, ring, mesh, a foam, or felt.

E-11. The water electrolyzer of E-1 to E-10,
wherein the anode/cathode pairs each are applied with an independent operating potential.

E-12. The water electrolyzer of E-1 to E-11, further comprising:
a variable pump or valve to control the flow rate of electrolyte through the electrolyzer.

F-1. A system for capturing atmospheric carbon dioxide comprising:
carbonation racks comprising trays of pellets, the pellets comprising the wet mixture of metal hydroxide and salt;
a liberation vessel comprising an acidic solution for dissolving metal carbonates to produce CO₂ and metal ions;
a regeneration vessel comprising a basic solution for precipitating metal hydroxide particles from metal ions;
a solids separation tank configured to separation metal hydroxide particles for pellet formation for use in the carbonation racks; and
a water electrolyzer to supply acids and bases to the liberation vessel and regeneration vessel.

G-1. A system for capturing atmospheric carbon dioxide comprising:
the direct air capture system of C-1 to C-9,
the sorbent processing system of D-1 to D-11, and
the water electrolyzer of E-1 to E-12.

G-2. The system of G-1,
wherein the system is at least partially supplied with energy by intermittent renewable energy.

G-3. The system of G-1 to G-2,
further comprising an energy recovery system to convert hydrogen produced by the water electrolyzer to electricity.

G-4. The system of G-3,
wherein the energy recovery system at least partially supplies energy for the water electrolyzer.

G-5. The system of G-1 to G-4, further comprising:
an acid tank for storing an acidic solution produced by the water electrolyzer, and
a base tank for storing a basic solution produced by the water electrolyzer,

G-6. The system G-5,
wherein the acid and base tanks are thermally insulated.

G-7. The system of G-1 to G-6, further comprising:
a CO₂ storage tank.

G-8. The system of G-1 to G-7, further comprising:
a H₂ storage tank.

1. A system for capturing atmospheric carbon dioxide comprising:
carbonation racks comprising trays of pellets, the pellets comprising the wet mixture of metal hydroxide and salt;
a liberation vessel comprising an acidic solution for dissolving metal carbonates to produce CO₂ and metal ions;
a regeneration vessel comprising a basic solution for precipitating metal hydroxide particles from metal ions;
a solids separation tank configured to separate metal hydroxide particles for pellet formation for use in the carbonation racks; and
a water electrolyzer to supply acids and bases to the liberation vessel and regeneration vessel.

2. A system for capturing atmospheric carbon dioxide comprising:
a direct air capture system comprising a wet mixture of metal hydroxide and salt, wherein the metal hydroxide is crystalline, non-crystalline, or amorphous and is selected from the group consisting of (i) alkaline earth hydroxides, preferably calcium hydroxide, calcium magnesium hydroxide, magnesium hydroxide, (ii) calcium silicate hydrates, including tobermorite, afwillite, jennite, and xonotlite, (iii) magnesium carbonate hydrates, including magnesium carbonate hydroxide, dypingite, artinite, lansfordite, hydromagnesite, nesquehonite, barringtonite, (iv) magnesium silicate hydrates, including lizardite, serpentine, talc, antigorite, and (v) mixtures thereof, wherein the salt is a hygroscopic salt which may be mixed with a fraction of an alkali metal hydroxide;
a sorbent processing system comprising a liberation vessel comprising an acidic solution for dissolving metal carbonates to produce CO₂ and metal ions, wherein the acidic solution has a temperature of 20-90° C., preferably 30-80° C., or most preferably 40-70° C. and a salt concentration of at least 0.01M; and
a water electrolyzer comprising a plurality of anode/cathode pairs, an inlet configured to flow electrolyte to the plurality of anode/cathode pairs, an acid solution channel and outlet, a basic solution channel and outlet, a divider between the acid solution channel and the basic solution channel, wherein there is no membrane or divider between the anode and cathode of each anode/cathode pair.

3. The system of claim 2,
wherein the system is at least partially supplied with energy by intermittent renewable energy.

4. The system of claim 2, further comprising:
an acid tank for storing an acidic solution produced by the water electrolyzer, and
a base tank for storing a basic solution produced by the water electrolyzer.

5. The system of claim 4,
wherein the acid and base tanks are thermally insulated.

6. The system of claim 2, further comprising:
a CO₂ storage tank.

7. The system of claim 2,
further comprising an energy recovery system to convert hydrogen produced by the water electrolyzer to electricity.

8. The system of claim 8,
wherein the energy recovery system at least partially supplies energy for the water electrolyzer.

9. The system of claim 2, further comprising:
a H₂ storage tank.

10. A direct air capture system comprising:
a wet mixture of metal hydroxide and salt.

11. The direct air capture system of claim 10,
wherein the metal hydroxide is calcium hydroxide.

12. The direct air capture system of claim 10,
wherein the metal hydroxide is crystalline, non-crystalline, or amorphous and is selected from the group consisting of (i) alkaline earth hydroxides, preferably calcium hydroxide, calcium magnesium hydroxide, magnesium hydroxide, (ii) calcium silicate hydrates, including tobermorite, afwillite, jennite, and xonotlite, (iii) magnesium carbonate hydrates, including magnesium carbonate hydroxide, dypingite, artinite, lansfordite, hydromagnesite, nesquehonite, barringtonite, (iv) magnesium silicate hydrates, including lizardite, serpentine, talc, antigorite, and (v) mixtures thereof.

13. The direct air capture system of claim 10,
wherein the salt is a hygroscopic salt which may be mixed with a fraction of an alkali metal hydroxide.

14. The direct air capture system of claim 10, further comprising:
vertically stacked trays containing pellets comprising the wet mixture of metal hydroxide and salt.

15. The direct air capture system of claim 10, further comprising:
a sprayer, mister, or applicator configured to apply water to the wet mixture of metal hydroxide and salt.

16. The direct air capture system of claim 10,
wherein the wet mixture of metal hydroxide is comprised of particles having a mean diffusion distance under 10 mm.

17. The direct air capture system of claim 10,
wherein the wet mixture of metal hydroxide further comprises an inert material.

18. The direct air capture system of claim 10, further comprising:
carbonation racks comprising trays of pellets, the pellets comprising the wet mixture of metal hydroxide and salt, wherein the carbonation racks support and provide ballast for photovoltaic panels.

19. A sorbent processing system for carbon dioxide liberation and metal hydroxide regeneration comprising:
a liberation vessel comprising an acidic solution for dissolving metal carbonates to produce CO₂ and metal ions, wherein the acidic solution has a temperature of 20-90° C., preferably 30-80° C., or most preferably 40-70° C. and a salt concentration of at least 0.01M.

20. The sorbent processing system of claim 19, further comprising:
a regeneration vessel comprising a basic solution for precipitating metal hydroxide particles from metal ions, wherein the basic solution has a temperature of 20-90° C., preferably 30-80° C., or most preferably 40-70° C. and a salt concentration of at least 0.01M.

21. The sorbent processing system of claim 19, further comprising:
a solids separation tank, wherein the solids separation tank utilizes a centrifuge, precipitation, coagulation floatation, flocculation, spray drying, pellet reactor, sieving, filtration, or another similar method of solids-liquid separation.

22. The sorbent processing system of claim 19,
wherein the metal carbonate is calcium carbonate.

23. The sorbent processing system of claim 19,
wherein the regeneration vessel further comprises a stirrer or shearer.

24. The sorbent processing system of claim 20,
wherein the metal hydroxide particles precipitated have a particle size of less than 1 micron.

25. The sorbent processing system of claim 20,
wherein the metal carbonates are sourced from the direct air capture system comprising:
carbonation racks comprising trays of pellets, the pellets comprising the wet mixture of metal hydroxide and salt;
a liberation vessel comprising an acidic solution for dissolving metal carbonates to produce CO₂ and metal ions;
a regeneration vessel comprising a basic solution for precipitating metal hydroxide particles from metal ions;
a solids separation tank configured to separate metal hydroxide particles for pellet formation for use in the carbonation racks; and
a water electrolyzer to supply acids and bases to the liberation vessel and regeneration vessel.

26. The sorbent processing system of claim 20, further comprising:
wherein the solids separation tank is configured to separate metal hydroxide particles for pellet formation for use in the carbonation racks.

27. The sorbent processing system of claim 20, further comprising:
a pre-treatment tank for exposing sorbent or partially reacted sorbent to CO₂ prior to entering the liberation vessel.

28. The sorbent processing system of claim 20,
wherein the liberation vessel or a tank upstream or downstream of the liberation vessel further comprises an inert solids separator selected from the group consisting of a surface skimmer, a bottom rake, a pump, a filter, or a belt filter press.

29. The sorbent processing system of claim 20,
wherein a tank downstream of the liberation vessel and upstream of the regeneration vessel further comprises an inert solids separator selected from the group consisting of a sedimentation tank.

30. A water electrolyzer comprising:
a plurality of anode/cathode pairs,
an inlet configured to flow electrolyte to the plurality of anode/cathode pairs,
an acid solution channel and outlet,
a basic solution channel and outlet,
a divider between the acid solution channel and the basic solution channel,
wherein there is no membrane or divider between the anode and cathode of each anode/cathode pair.

31. The water electrolyzer of claim 30, further comprising:
a hydrogen outlet and an oxygen outlet.

32. The water electrolyzer of claim 30, further comprising:
an electrolyte solution, wherein the electrolyte has a pH between 7-14.

33. The water electrolyzer of claim 30,
wherein the inlet is fluidly connected to a source of water containing electrolyte having a pH between 7-14.

34. The water electrolyzer of claim 30,
wherein the inlet is fluidly connected to a coagulation or settling tank and is configured to draw solution from said coagulation or settling tank and deliver it to the electrolyzer.

35. The water electrolyzer of claim 30,
wherein a water softening or treatment tank is provided between the inlet and the coagulation or settling tank.

36. The water electrolyzer of claim 30,
wherein the fluid in the electrolyzer has a temperature of 20-90° C., preferably 30-80° C., or more preferably 40-70° C.

37. The water electrolyzer of claim 30,
wherein the anode/cathode pairs are electrodes comprising a geometry selected from the group consisting of flow-through and flow-by meshes, plates, foams, and other materials arranged at an offset angle with respect to adjacent electrodes.

38. The water electrolyzer of claim 30,
wherein the anode/cathode pairs are spatially arranged in the direction of fluid flow through the water electrolyzer such that each successive pair is arranged downstream of a prior pair.

39. The water electrolyzer of claim 30,
wherein each electrode comprises a sheet, plate, wire, ring, mesh, a foam, or felt.

40. The water electrolyzer of claim 30,
wherein the anode/cathode pairs each are applied with an independent operating potential.

41. The water electrolyzer of claim 30, further comprising:
a variable pump or valve to control the flow rate of electrolyte through the electrolyzer.
